(19) United States
(12) Patent Application Publication
(10) Pub. No.: US 2008/0074481 A1
(43) Pub. Date: Mar. 27, 2008

(54) INKJET PRINTER AND PRINTING METHOD

(76) Inventor: Harumichi Doo, Hamamatsu-city (JP)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/859,598

(22) Filed: Sep. 21, 2007

(30) Foreign Application Priority Data
Jan. 18, 2007 (JP) JP2007-009043
Sep. 22, 2006 (JP) JP2006-258090

(51) Int. Cl. B41J 2/01

(52) U.S. Cl. 347/102

(57) ABSTRACT

The present invention relates to an inkjet printer. The inkjet printer includes a housing and an ink head slidably moveable within the housing along a first direction, the ink head for discharging ink on a medium transport through the housing along a second direction. Also included is a first irradiation means slidably moveable with the ink head for irradiating the ink discharging on the medium, and a second irradiation means formed on the housing for irradiating the ink discharged on the medium after irradiation by the first irradiation means, wherein an irradiation strength of the second irradiation means is greater than an irradiation strength of the first irradiation means.

### CROSS-REFERENCE TO RELATED APPLICATIONS

Pursuant to 35 U.S.C. § 119(a), this application claims the benefit of earlier filing date and right of priority to Japanese Application No. 2007-009043, filed on Jan. 18, 2007 and Japanese Application No. 2006-258090, filed on Sep. 22, 2006, the contents of which are hereby incorporated by reference herein in their entirety.

### FIELD OF THE INVENTION

The present invention relates to an inkjet printer and to a method for printing in an inkjet printer using ink cured by ultraviolet light irradiation.

### BACKGROUND OF THE INVENTION

In the related art, an inkjet printer utilizing ultraviolet light curing ink is known. Specifically, the printer discharges the ink on a medium, and the ink is cured upon being irradiated with ultraviolet light thereafter. The source of the ultraviolet light may be an ultraviolet light irradiating lamp installed inside the printer.

The related art inkjet printer utilizing the ultraviolet light curing ink is designed such that the ultraviolet light curing ink is discharged from the inkjet onto a medium that is the object of a print job. By irradiating the ink discharged onto a printing surface of the medium, the ink can be cured and fixed onto the printing surface.

Accordingly, the related art inkjet printer utilizing the ultraviolet light curing ink is advantageous in that it is possible to print on various types of media in addition to paper. Currently, the related art inkjet printer is widely employed.

However, problems associated with the related art inkjet printer using ultraviolet light curing ink exist. For example, because the related art inkjet printer is designed to immediately irradiate the ink once it is discharged onto the medium, curing of the ink occurs before the ink is uniformly spread on the medium. Accordingly, the ink is cured with irregularities, which may cause lines to appear on the printed surface of the medium. Moreover, the printed surface may have a granular feel or matte finish. Thus, the printed surface does not have a smooth or glossy surface.

Another problem with the related inkjet printer is that the ultraviolet light lamp operates at a high temperature. Thus, when high-temperature heat is incident on the medium, the medium may deform and come into contact with a printing head of the printer.

### SUMMARY OF THE INVENTION

The present invention is directed to an inkjet printer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in an inkjet printer comprising a housing, an ink head slidably moveable within the housing along a first direction, the ink head for discharging ink on a medium transported through the housing along a second direction, a first irradiation means slidably moveable with the ink head for irradiating the ink discharged on the medium, and a second irradiation means formed on the housing for irradiating the ink discharged on the medium after irradiation by the first irradiation means, wherein an irradiation strength of the second irradiation means is greater than an irradiation strength of the first irradiation means.

Preferably, the ink discharged from the ink head is ultraviolet light curing ink. Preferably, the first irradiation means comprises at least one ultraviolet light emitting diode and the second irradiation means comprises at least one ultraviolet light irradiating lamp. Preferably, an ultraviolet light emitted from the first irradiation means has a wavelength of 360-420 nm, and an ultraviolet light emitted from the second irradiation means has a wavelength of 240-280 nm.

In one aspect of the invention, the ink head discharges ink on the medium while moving along the first direction. Furthermore, the ink head is capable of discharging ink on the medium while moving in at least one of a forward first direction and a backward first direction. Moreover, the first irradiation means irradiates the ink discharged on the medium while the ink head moves along the first direction.

In another aspect of the invention, an ultraviolet light emitted from the first irradiation means internally cures the ink discharged on the medium, and an ultraviolet light emitted from the second irradiation means externally cures the ink discharged on the medium.

In accordance with another embodiment of the invention, a method for printing on a medium comprises discharging ink from an ink head on a medium, wherein the ink head is slidably moveable within a housing along a first direction and the medium is transported through the housing along a second direction, irradiating the ink discharged on the medium using a first irradiation means, and irradiating the ink discharged on the medium using a second irradiation means after irradiation by the first irradiation means, wherein an irradiation strength of the second irradiation means is greater than an irradiation strength of the first irradiation means.

Preferably, the ink discharged from the ink head is ultraviolet light curing ink. Preferably, the first irradiation means comprises at least one ultraviolet light emitting diode and the second irradiation means comprises at least one ultraviolet light irradiating lamp. Preferably, an ultraviolet light emitted from the first irradiation means has a wavelength of 360-420 nm, and an ultraviolet light emitted from the second irradiation means has a wavelength of 240-280 nm.

In one aspect of the invention, the method further comprises discharging the ink from the ink head on the medium while moving along the first direction. Furthermore, the ink head is capable of discharging ink on the medium while moving in at least one of a forward first direction and a backward first direction. Preferably, the method further comprises irradiating the ink discharged on the medium using the first irradiation means while the ink head moves along the first direction.

In another aspect of the invention, the method further comprises internally curing the ink discharged on the medium with an ultraviolet light emitted from the first irradiation means, and externally curing the ink discharged on the medium with an ultraviolet light emitted from the second irradiation means

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a perspective view of an inkjet printer, in accordance with one embodiment of the present invention.

FIG. 2 is a side view of the inkjet printer corresponding to an arrow A in FIG. 1, in accordance with one embodiment of the present invention.

FIG. 3 illustrates an ink head of the inkjet printer, in accordance with one embodiment of the present invention.

FIGS. 4(a) and 4(b) illustrate a first stage of an ultraviolet light irradiation process viewed from a direction indicated by an arrow B in FIG. 2, in accordance with one embodiment of the present invention.

FIG. 4(c) illustrates a state of ultraviolet light curing ink undergoing an ultraviolet light irradiation process, in accordance with one embodiment of the present invention.

FIGS. 4(d) and (e) are cross-sectional views along line IV-IV in FIG. 1 illustrating a second stage of the ultraviolet light irradiation process, in accordance with one embodiment of the present invention.

### DETAILED DESCRIPTION OF THE PREFERRED EMBODIMENTS

The present invention relates to an inkjet printer and a method for printing in an inkjet printer using ink cured by ultraviolet light irradiation.

Hereinafter, the term “medium” in the present specification, may refer to various types of media. These include, for example, paper types such as ordinary paper and the like, as well as various types of non-paper materials, such as resin-type materials such as PVC, polyester, and the like, or materials such as aluminum, iron, wood, and the like.

Moreover, references to an inkjet method in the present specification may refer to printing methods in accordance with inkjet technology that employ various types of known methods that have been previously used. These methods include, for example, various types of continuous formats, such as a binary deflection format, a continuous deflection format, and the like, or various types of on-demand formats such as a thermal format or a piezoelectric element format, and the like.

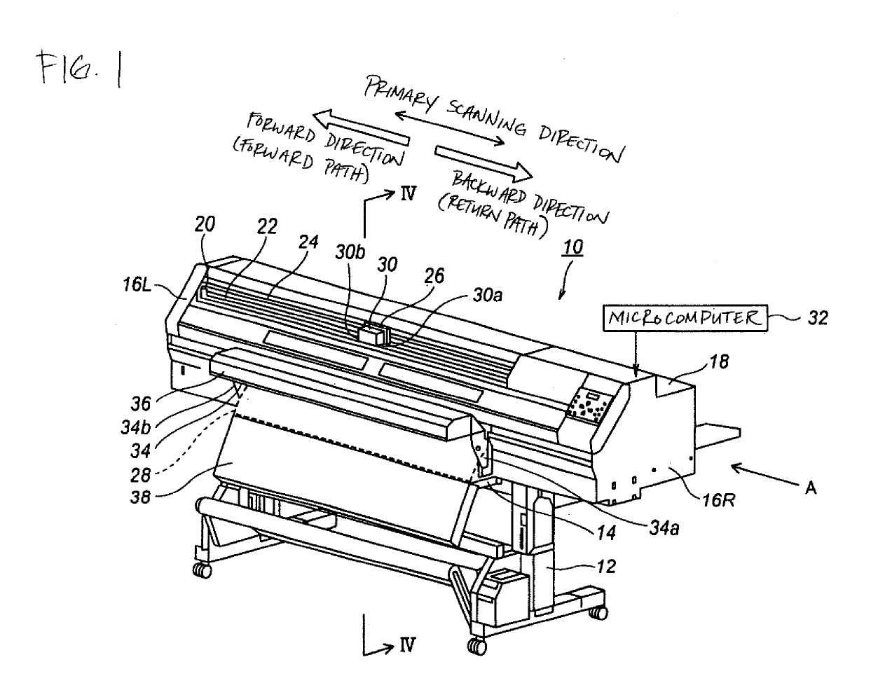

Referring to FIGS. 1-4, a preferred embodiment of the present invention is illustrated. Preferably, the present invention solves the problems of the prior art by providing an inkjet printer and printing method capable of producing a glossy finish on a printed surface of a medium. Moreover, the present invention prevents damage to the medium caused by heat generated from a printer lamp.

In accordance with the present invention, a first ultraviolet light irradiation means is disposed on a side of an ink head in the inkjet printer. A second ultraviolet light irradiation means is disposed in the vicinity of a transport outlet port for a medium that is the object of a print job. Preferably, an ultraviolet light irradiation strength of the first ultraviolet light irradiation means has a low setting while an ultraviolet light irradiation strength of the second ultraviolet light irradiation means has a high setting.

Accordingly, for an inkjet printer with which ultraviolet light curing ink is discharged from an ink head on a transported medium and printing is performed, the printer comprises a first ultraviolet light irradiation means arranged in the vicinity of an inkjet that irradiates the ultraviolet light curing ink discharged on the medium. Moreover, a second ultraviolet light irradiation means is positioned on a downstream side with respect to the first ultraviolet light irradiation means in a transport direction of the medium, and irradiates the ultraviolet light curing ink with light that is stronger than that a light emitted by the first ultraviolet light irradiation means. In one aspect of the invention, the first ultraviolet light irradiation means is an ultraviolet light emitting diode, and the second ultraviolet light irradiation means is an ultraviolet light irradiating lamp.

Preferably, for the inkjet printer, a wavelength of the ultraviolet light irradiated from the first ultraviolet light irradiation means is between 360 nm and 420 nm. Preferably, a wavelength of the ultraviolet light irradiated from the second ultraviolet light irradiation means is between 240 nm and 280 nm. Preferably, the ultraviolet light curing ink is cured internally by the first ultraviolet light irradiation means and cured externally by the second ultraviolet light irradiation means.

In accordance with the present invention, a printing method of an inkjet printer in which ultraviolet light curing ink is discharged from an inkjet on a medium that is transported and printing performed, the printing method comprises a first ultraviolet light irradiation process in which ultraviolet light curing ink discharged on a medium from an inkjet is irradiated with ultraviolet light. The printing method further comprises a second ultraviolet light irradiation process, wherein after the ink is irradiated with ultraviolet light by the first ultraviolet light irradiation process, the ink is then irradiated with ultraviolet light that is stronger than the light emitted during the first ultraviolet light irradiation process.

Preferably, for the printing method, a wavelength of the ultraviolet light irradiated from the first ultraviolet light irradiation means is between 360 nm and 420 nm. Preferably, a wavelength of the ultraviolet light irradiated from the second ultraviolet light irradiation means is between 240 nm and 280 nm. Preferably, the ultraviolet light curing ink is cured internally by the first ultraviolet light irradiation means and cured externally by the second ultraviolet light irradiation means.

The present invention is advantageous in that a finished state of a printed surface of a medium can be made smooth or have a glossy finish using an inkjet printer. Moreover, damage to the medium caused by heat from an inkjet lamp is avoided.

Preferred embodiments of the present invention will be further described below with reference to FIGS. 1-4. In the present invention, the ultraviolet light curing ink used is preferably one in which a photopolymerization initiator is contained at an overall level of 1-5%.

FIG. 1 is a perspective view of an inkjet printer, in accordance with one embodiment of the present invention. Referring to FIG. 1, an inkjet printer 10 is preferably a paper-moving type printer comprising a fixed group base member 14 supported by a pedestal member 12 and extended in a primary scanning direction. Side members 16L and 16R are respectively arranged on right and left ends of the base member 14, and are perpendicular to the base member 14. A side unit 18 is formed at sides of the side members 16L and 16R. A center wall 20 links the side members 16L and 16R. A guide rail 22 is formed on a wall surface of the center wall 20 and extends in the primary scanning direction. A wire 24 is arranged parallel to the wall surface of the center wall 20 such that the wire 24 is free to move in the primary scanning direction. A holder 26 is mounted to the wire 24 such that the holder 26 is free to slide on the guide rail 22. An ink head 30 is coupled to the holder 26 such that the ink head 30 faces a medium 28 positioned on the base 14. Accordingly, the ink head 30 may discharge ultraviolet light curing ink onto the medium 28.

In one aspect of the present invention, in the inkjet printer 10, recording paper may be used as the medium on which printing is done by means of the ultraviolet light curing ink discharged from the ink head 30. Preferably, the medium 28 is supplied to the base member 14 by a paper supply device (not shown). The paper may have a specified length in the primary scanning direction, which is the direction along a width of the paper. Preferably, the recording paper is transported through the inkjet printer 10 in a direction perpendicular to the primary scanning direction, which is the direction along a length of the paper. Hereinafter, the direction perpendicular to the primary scanning direction will be referred to as a secondary scanning direction.

Ultraviolet light emitting diodes (LEDs) 30a and 30b are installed near the ink head 30. Preferably, the ultraviolet LEDs 30a and 30b are respectively formed on two side surfaces of the ink head 30 in the primary scanning direction and constitute a first ultraviolet light irradiation means for irradiating a printing surface of the medium 28. In one aspect of the invention, ultraviolet light from the ultraviolet LEDs 30a and 30b do not have any heat energy.

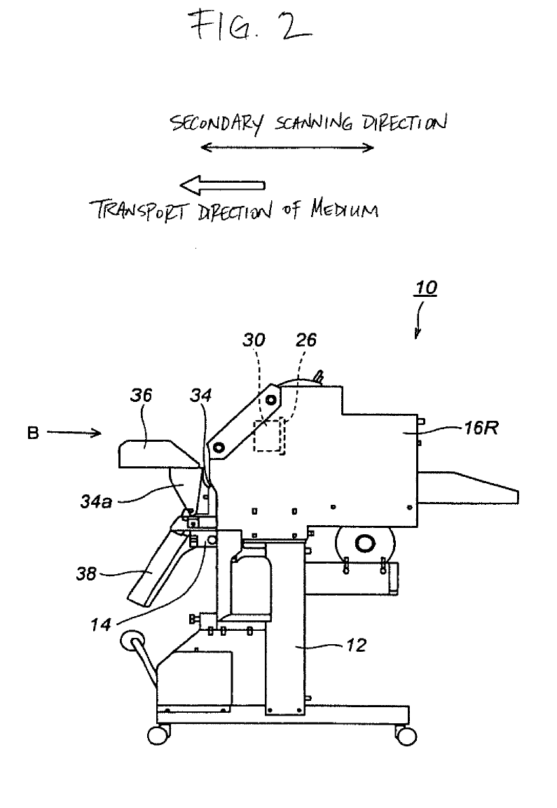

FIG. 2 is a side view of the inkjet printer corresponding to an arrow A in FIG. 1, in accordance with one embodiment of the present invention. Referring to FIGS. 1 and 2, a transport outlet port 34 is disposed along a transport direction of the medium 28 in the secondary scanning direction. Preferably, after a printing process is completed on the medium 28, the medium 28 exits out of a printing mechanism of the inkjet printer 10 through the transport outlet port 34 in the transport direction.

An ultraviolet light irradiating lamp 36 preferably having a width similar to a width of the transport outlet port 34 in the primary scanning direction is formed on an upper portion of the transport outlet port 34. The ultraviolet light irradiating lamp 36 constitutes a second ultraviolet light irradiation means for irradiating with ultraviolet light the printed surface of the medium 28 exiting through the transport outlet port 34. Preferably, the ultraviolet light irradiating lamp 36 is positioned “downstream” of, or after, the ultraviolet LEDs 30a and 30b with respect to the direction of movement of the medium 28 in the inkjet printer 10. In one aspect of the present invention, an ultraviolet light irradiation strength of the ultraviolet LEDs 30a and 30b is low and the ultraviolet light irradiation strength of the ultraviolet light irradiating lamp 36 is high.

In accordance with the present invention, the LEDs 30a and 30b preferably have ultraviolet light wavelengths between 360 and 420 nm and ultraviolet light strengths between 1 and 2 W/cm². The ultraviolet light irradiating lamp 36 preferably has an ultraviolet wavelength between 240 and 280 nm or between 360 and 420 nm. Accordingly, a 100 W/cm metal halide lamp having an ultraviolet wavelength between 240 and 280 nm or between 360 and 420 nm may be used, for example.

Preferably, the ultraviolet light irradiating lamp 36 is fixed to the base member 14 through support members 34a and 34b. Specifically, the support member 34a couples one end of the transport outlet port 34 to one end of the ultraviolet light irradiating lamp 36 and the support member 34b couples the other end of the transport outlet port 34 to the other end of the ultraviolet light irradiating lamp 36. Moreover, a guide 38 is formed on a lower portion of the transport outlet port 34 and acts as a transport path for the medium 28 after the medium 28 exits through the transport outlet port 34.

In accordance with the present invention, operation of the inkjet printer 10 is controlled by a microcomputer 32. Therefore, printing on the medium 28 is performed in accordance with the control of the microcomputer 32.

In accordance with the present invention, when the wire 24 moves by means of a reel for the wire 24, the ink head 30 coupled to the holder 26 can move back and forth in unison with the movement of the wire 24. Thus, the ink head 30 is able to move in a forward primary scanning direction (forward path) and a backward primary scanning direction (return path). Accordingly, printing according to the movement of the ink head 30 may be performed on the medium 28 that is supplied to the base member 14 by the paper supply device.

In accordance with one embodiment of the present invention, the inkjet printer 10 may perform bi-directional printing on the medium 28. For example, as the ink head 30 sequentially moves in the forward and backward direction, ultraviolet light curing ink may be discharged on the medium 28 when the ink head 30 moves along the forward path, as well as when the ink head 30 moves along the return path. Alternatively, the inkjet printer may also perform uni-directional printing. For example, as the ink head 30 sequentially moves in the forward and backward direction, ultraviolet light curing ink may be discharged on the medium 28 when the ink head 30 moves along either one of the forward path and return path.

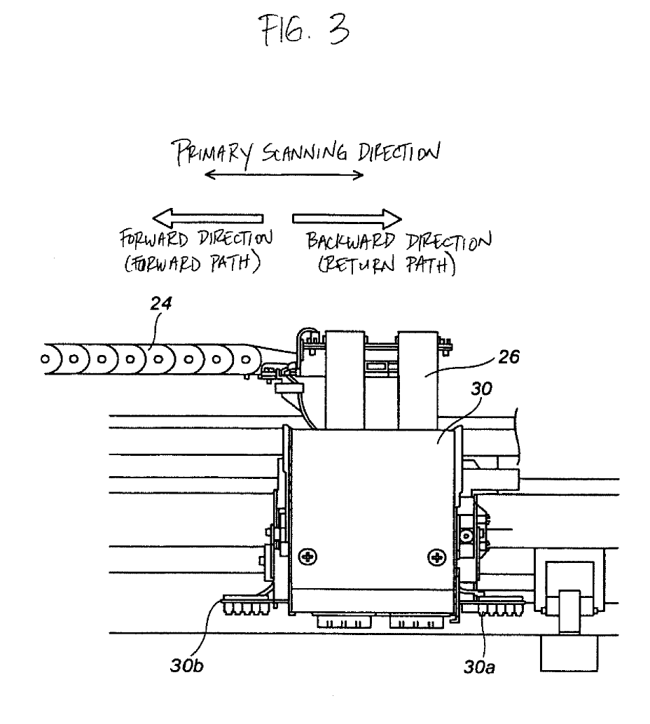

FIG. 3 illustrates an ink head of the inkjet printer, in accordance with one embodiment of the present invention. Referring to FIG. 3, bi-directional and uni-directional printing in the inkjet printer 10 will be described in accordance an embodiment of the present invention. Preferably, the ultraviolet light curing ink used comprises a photopolymerization initiator and has a high sensitivity to ultraviolet light irradiation, wherein the ultraviolet light has a wavelength between 240-280 nm or 360-420 nm.

During a bi-directional printing process, the two ultraviolet LEDs 30a and 30b and the ultraviolet light irradiating lamp 36 are first switched to an on-state. Thereafter, when printing is started, the ink head 30 moves in the forward primary scanning direction from a standby position (not shown). For example, the standby position describes when the ink head 30 is set near a side member 16R end section. Accordingly, as the ink head 30 moves, the ultraviolet light curing ink is discharged from a discharge orifice to begin printing on the medium 28.

During printing, because the ultraviolet LED 30a is in an on-state, the light from the ultraviolet LED 30a is irradiated onto the ultraviolet light curing ink discharged on the medium 28. Afterward, when the ink head 30 reaches a side member 16L end section, the ink head 30 will transition to moving in the backward primary scanning direction. Similar to the operation carried out in the forward direction, the ultraviolet light curing ink is discharged onto the medium 28 from the ink head 30 as the ink head 30 moves in the backward direction. Accordingly, as the ultraviolet light curing ink is discharged onto the medium 28, it is irradiated by the light from the ultraviolet LED 30b. As described above, the series of operations in the forward path and return path explain a first stage of an ultraviolet light irradiation process for bi-directional printing.

As the bi-directional printing on the medium 28 progresses, the medium 28 gradually moves in the transport direction (see FIG. 2). When a portion of the medium 28 for which printing is completed is brought out from the transport outlet port 34, the medium 28 passes below the ultraviolet light irradiating lamp 36 disposed on the upper portion of the transport outlet port 34. Thus, as the medium 28 is moved to the guide 38, it is irradiated with ultraviolet light from the irradiating lamp 36. Accordingly, irradiation of the medium 28 by the ultraviolet light irradiating lamp 36 describes a second stage of the ultraviolet light irradiation process for bi-directional printing.

During a uni-directional printing process, printing is performed in one direction, preferably the forward primary scanning direction. Accordingly, the ultraviolet LED 30a is preferably switched to an on-state while the ultraviolet LED 30b is switched to an off-state. Moreover, the ultraviolet light irradiating lamp 36 is switched to an on-state.

When the printing begins, the ink head 30 moves in the primary scanning direction from the standby position (not shown). For example, the standby position describes when the ink head 30 is set near the side member 16R end section. Accordingly, as the ink head 30 moves, the ultraviolet light curing ink is discharged from the discharge orifice to begin printing on the medium 28.

During printing, because the ultraviolet LED 30a is in an on-state, the light from the ultraviolet LED 30a is irradiated onto the ultraviolet light curing ink discharged on the medium 28. Afterward, when the ink head 30 reaches the side member 16L end section, the ink head 30 will transition to moving in the backward primary scanning direction. However, printing while moving in the backward direction (return path) is not performed. As described above, the series of operations in the forward path and return path explain a first stage of an ultraviolet light irradiation process for uni-directional printing.

A second stage of the ultraviolet light irradiation process for uni-directional printing is similar to the second stage of the ultraviolet light irradiation process for bi-directional printing. Preferably, when a portion of the medium 28 for which printing is completed is brought out from the transport outlet port 34, the medium 28 passes below the ultraviolet light irradiating lamp 36 disposed on the upper portion of the transport outlet port 34. Thus, the medium 28 is irradiated with light from the ultraviolet light irradiating lamp 36 as it moves in the transport direction.

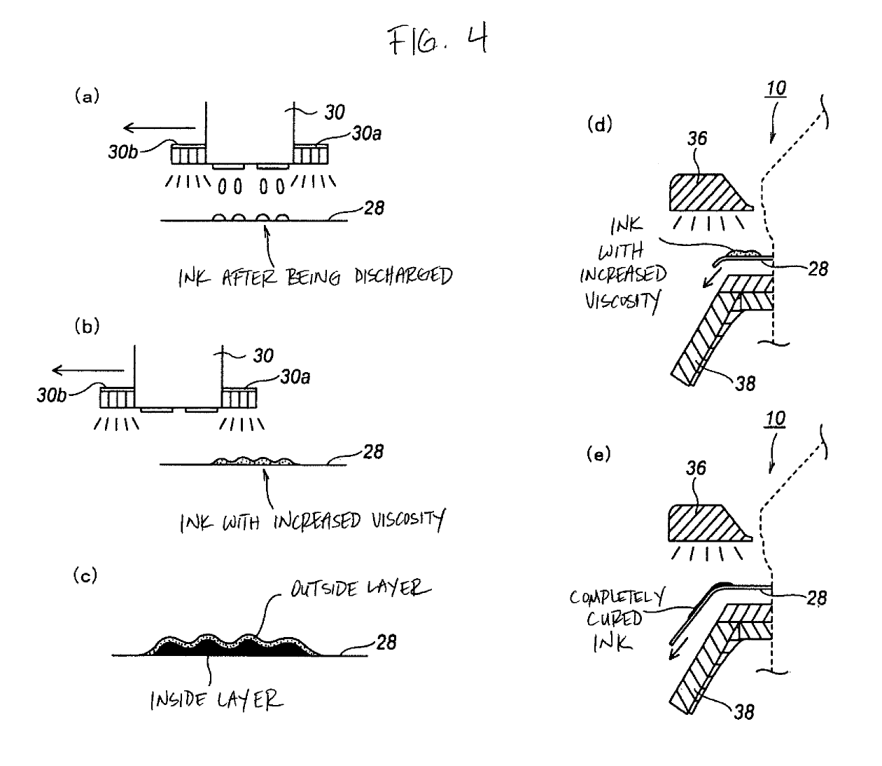

In accordance with the present invention, because ultraviolet light irradiation is carried out in two stages when printing is performed by the inkjet printer 10, a state of the ultraviolet light curing ink undergoes changes. Referring to FIGS. 4(a)-4(e), the state changes of the ultraviolet light curing ink are explained.

FIGS. 4(a) and 4(b) illustrate a first stage of an ultraviolet light irradiation process viewed from a direction indicated by an arrow B in FIG. 2, in accordance with one embodiment of the present invention. FIG. 4(c) illustrates a state of ultraviolet light curing ink undergoing an ultraviolet light irradiation process, in accordance with one embodiment of the present invention. FIGS. 4(d) and (e) are cross-sectional views along line IV-IV in FIG. 1 illustrating a second stage of the ultraviolet light irradiation process, in accordance with one embodiment of the present invention.

Referring to FIGS. 4(a) and 4(b), in accordance with the present invention, the ultraviolet LEDs 30a and 30b arranged on both side surfaces of the ink head 30 irradiate ultraviolet light having a lower irradiation strength than a light irradiation strength of the ultraviolet light irradiating lamp 36. Accordingly, the ultraviolet light curing ink discharged on the medium 28 becomes viscous during the first stage ultraviolet light irradiation process and does not completely cure. Hence, during the first stage ultraviolet light irradiation process, the ultraviolet light curing ink discharged on the medium 28 is transported in a state of increased viscosity with some fluidity remaining. As shown in FIG. 4(c), when a state of an ink interior has an increased viscosity, a state of the ink's inner layer is different from an outer layer.

Moreover, when the ultraviolet light curing ink is discharged and irradiated with ultraviolet light by the LEDs 30a and 30b, the ink gradually cures internally because of the photopolymerization initiator reacting with the ultraviolet light having a wavelength between 360 and 420 nm. Thus, the inner layer of the ultraviolet light curing ink can begin adhering to the medium 28 before the outside layer. Hence, because of the photopolymerization initiator, the polymerization of the ink component begins at the inner layer while the outside layer is in a state of increased viscosity and not yet completely fixed. Therefore, because the fluidity of the outside layer remains viscous, the surface of the outside layer can gradually spread uniformly and become flat as it cures.

Referring to FIGS. 4(d) and 4(e), during the second stage of the ultraviolet light irradiation process, the ultraviolet light curing ink on the medium 28 for which the fluidity remains in a state of increased viscosity passes below the ultraviolet light irradiating lamp 36. By doing so, the ink is irradiated with ultraviolet light from the ultraviolet light irradiating lamp 36, which has greater irradiation strength than the light from the LEDs 30a and 30b. Moreover, the light from the irradiating lamp 36 has a wavelength between 240 and 280 nm or 360 and 420 nm. Accordingly, the ultraviolet light curing ink on the medium 28 becomes completely cured.

In accordance with present invention, because the ultraviolet light irradiation process is performed in two stages using two types of ultraviolet light irradiation means (i.e., the UV LEDs 30a and 30b and the ultraviolet light irradiating lamp 36) having different irradiation strengths, a printed surface of the medium 28 may have a smooth glossy state. Additionally, because the viscosity of the ultraviolet light curing ink is increased during the first stage of the ultraviolet light irradiation process, the ultraviolet light curing ink is prevented from running during printing. Hence, uneven printing on the medium 28 is prevented.

In accordance with the present invention, an inner layer of the ultraviolet light curing ink may be partially cured by the UV LEDs 30a and 30b as the ink is dispersed on the medium 28. Thereafter, as the ultraviolet light irradiating lamp 36 completely cures an outer portion of the ink, the inner layer of the ink is also completely cured via light having a wavelength between 360 and 420 nm from the lamp 36.

In accordance with the present invention, the UV LEDs 30a and 30b are installed on the ink head 30. Preferably, an increase in weight of the ink head 30 can be controlled. Moreover, a load on the ink head 30 may be lightened.

In accordance with the present invention, a surface area of the medium 28 that is directly under and facing the ink head 30 is irradiated by a comparatively low strength ultraviolet light having a wavelength between 360 and 420 nm from the UV LEDs 30a and 30b. Moreover, the medium 28 does not contact the ink head 30. Thus, heat is not incident on the surface of the medium 28. Therefore, the medium 28 is not susceptible to warping or other irregularities when being processed.

In accordance with the present invention, and as shown in FIGS. 4(d) and 4(e), an area of the medium 28 that is irradiated with ultraviolet light by the ultraviolet light irradiating lamp 36 is not directly under the ink head 30. Thus, even if the medium 28 were to deform or crinkle, the medium 28 would not contact the ink head 30.

In accordance with the present invention, an inner layer of the ultraviolet light curing ink increases in viscosity when discharged onto the medium 28. After an outer layer of the ink spreads onto the medium 28 and becomes flat, both the inner and outer layer of the ink are cured. Accordingly, a printed surface of the medium 28 can be made smooth, and therefore, a glossy print can be achieved.

In the preferred embodiments described above, the present invention is implemented in a paper-moving type of inkjet printer. However, the present invention is not limited as such, and may be implemented in a flat-bed type of inkjet printer.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An inkjet printer comprising:
a housing,
an ink head slidably moveable within the housing along a first direction, the ink head for discharging ink on a medium transported through the housing along a second direction;
a first irradiation means slidably moveable with the ink head for irradiating the ink discharged on the medium; and
a second irradiation means formed on the housing for irradiating the ink discharged on the medium after irradiation by the first irradiation means, wherein an irradiation strength of the second irradiation means is greater than an irradiation strength of the first irradiation means.

2. The inkjet printer of claim 1, wherein the ink discharged from the ink head is ultraviolet light curing ink.

3. The inkjet printer of claim 1, wherein the first irradiation means comprises at least one ultraviolet light emitting diode and the second irradiation means comprises at least one ultraviolet light irradiating lamp.

4. The inkjet printer of claim 1, wherein an ultraviolet light emitted from the first irradiation means has a wavelength of 360-420 nm, and an ultraviolet light emitted from the second irradiation means has a wavelength of 240-280 nm.

5. The inkjet printer of claim 1, wherein the ink head discharges ink on the medium while moving along the first direction.

6. The inkjet printer of claim 5, wherein the ink head is capable of discharging ink on the medium while moving in at least one of a forward first direction and a backward first direction.

7. The inkjet printer of claim 5, wherein the first irradiation means irradiates the ink discharged on the medium while the ink head moves along the first direction.

8. The inkjet printer of claim 1, wherein an ultraviolet light emitted from the first irradiation means internally cures the ink discharged on the medium, and an ultraviolet light emitted from the second irradiation means externally cures the ink discharged on the medium.

9. A method for printing on a medium, the method comprising:
discharging ink from an ink head on a medium, wherein the ink head is slidably moveable within a housing along a first direction and the medium is transported through the housing along a second direction;
irradiating the ink discharged on the medium using a first irradiation means; and
irradiating the ink discharged on the medium using a second irradiation means after irradiation by the first irradiation means, wherein an irradiation strength of the second irradiation means is greater than an irradiation strength of the first irradiation means.

10. The method of claim 9, wherein the ink discharged from the ink head is ultraviolet light curing ink.

11. The method of claim 9, wherein the first irradiation means comprises at least one ultraviolet light emitting diode and the second irradiation means comprises at least one ultraviolet light irradiating lamp.

12. The method of claim 9, wherein an ultraviolet light emitted from the first irradiation means has a wavelength of 360-420 nm, and an ultraviolet light emitted from the second irradiation means has a wavelength of 240-280 nm.

13. The method of claim 9, further comprising discharging the ink from the ink head on the medium while moving along the first direction.

14. The method of claim 13, wherein the ink head is capable of discharging ink on the medium while moving in at least one of a forward first direction and a backward first direction.

15. The method of claim 13, further comprising irradiating the ink discharged on the medium using the first irradiation means while the ink head moves along the first direction.

16. The method of claim 9, further comprising:
internally curing the ink discharged on the medium with an ultraviolet light emitted from the first irradiation means; and
externally curing the ink discharged on the medium with an ultraviolet light emitted from the second irradiation means.
